(19) United States
(12) Patent Application Publication
(10) Pub. No.: US 2009/0251843 A1
(43) Pub. Date: Oct. 8, 2009

(54) VEHICLE-MOUNTED ELECTRONIC APPARATUS AND VEHICLE WITH THE SAME MOUNTED THEREIN

(75) Inventor: Ryoji Hironaka, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/303,465

(22) PCT Filed: May 29, 2007
(86) PCT No.: PCT/JP2007/061259

§ 371 Date: Dec. 4, 2008

(30) Foreign Application Priority Data
Jun. 7, 2006 (JP) 2006-158746

(51) Int. Cl. H05F 3/00

(52) U.S. Cl. 361/216

(57) ABSTRACT

An inverter unit includes a conductive housing (2) which is set to a ground potential, a control circuit board (17) accommodated in the housing (2), and a discharge gap (18) provided between a conductive pattern (92) formed at the control circuit board (17) and the housing (2) for discharging when a high voltage not less than a predetermined voltage is applied. Preferably, the inverter unit further includes a conductive plate (50) covering the control circuit board (17) and electrically connected with the conductive pattern (92). The discharge gap (18) is formed between the conductive plate (50) and the housing (2).

### TECHNICAL FIELD

The present invention relates to an electronic apparatus to be mounted in a vehicle, in particular, to a configuration for protecting the vehicle-mounted electronic apparatus.

### BACKGROUND ART

In order to provide protection against static electricity or overvoltage, a protection element for removing the overvoltage is generally provided in an electronic apparatus. An electronic control apparatus for a motor vehicle having such a protection element mounted therein is disclosed in Japanese Patent Laying-Open No. 2003-151794.

This electric control apparatus is an electronic control apparatus for a motor vehicle, configured of a case ground connected to a housing, and an electronic circuit connected to the case ground. This electronic circuit has a signal line for transmitting an output signal from a sensor to an integrated circuit, a connector having a terminal of the signal line and a control ground, a capacitor aiming at EMC protection provided between the signal line and the case ground, as well as an electrostatic protection element for allowing the charge applied to the capacitor to be discharged to the case ground.

An inverter unit, which is mounted in an electric vehicle or a hybrid vehicle and is connected to a motor for driving the vehicle, will be described as an example of the electronic apparatus for the vehicle. Note that other electronic apparatuses for a vehicle have a similar problem.

Precision mechanical equipment is accommodated in a housing of an inverter unit. At a time when static electricity tends to build up, such as in the winter season, static electricity can be applied to a terminal of a connector grounded to the housing, resulting in a damage to the precision mechanical equipment. In this case, it is preferable to allow static electricity to escape to a body earth on the way from the terminal to the precision mechanical equipment.

FIG. 13 shows a first study example illustrating a connection between an inverter unit and a control ECU (Electric Control Unit).

With reference to FIG. 13, a control ECU 508 and an inverter unit 502 are connected with a signal line 134 and a ground line 132.

At a control ECU 508 side, a zener diode D12 is provided between signal line 134 and ground line 132, and ground line 132 is electrically connected to a housing of control ECU 508. The housing of control ECU 508 is electrically connected to a body earth GNDB.

On the other hand, at an inverter unit 502 side, signal line 134 and ground line 132 are connected to a control circuit board 516 of the inverter inside a housing. On control circuit board 516, a zener diode D11 connected between signal line 134 and ground line 132 is provided. Ground line 132 is connected to a control ground GNDS on the circuit board. Note that control ground GNDS represents a reference potential of a signal provided by signal line 134.

Ground line 132 and the housing of inverter unit 502 are electrically connected inside inverter unit 502, and the housing is electrically connected to body earth GNDB.

When ground line 132 is connected to body earth GNDB via the housing at the control ECU 508 side and is connected to body earth GNDB via the housing as well at the inverter unit 502 side in this way, protection against overvoltage is sufficient but protection against noise may not be enough. It is because body earth GNDB is a frame of a vehicle, to be specific, and when ground line 132 serves as an outward trip the frame becomes a return trip. That is, a ground loop is formed along a path from ground line 132, the housing of the inverter, the vehicle frame, the housing of ECU, and back to ground line 132.

When the ground loop is formed, current flows through the loop due to the changes of magnetic flux which interlinks the loop. When current flows through the loop, the potential of ground line 502 becomes uneven and causes a trouble.

FIG. 14 is a second study example, showing a connection between the inverter unit and the control ECU.

The second study example shown in FIG. 14 is different from the first study example in FIG. 15 in that ground line 132 is not connected to the housing inside inverter unit 502. No description is repeated because FIG. 13 and FIG. 14 are the same in other parts.

According to the configuration shown in FIG. 14, the ground loop is not formed and the noise immunity performance is more improved than in the study example in FIG. 13.

FIG. 15 is a diagram for describing the problem of the study example shown in FIG. 14.

At the time of manufacturing of a vehicle, a worker sequentially attaches an ECU and an inverter unit to a frame. When inverter unit 502 is attached to the frame, the housing is connected to body earth GNDB, and then a wiring including signal line 134 and ground line 132 extending from control ECU 508 is inserted in a connector provided in the housing of inverter unit 502.

FIG. 15 shows a condition where signal line 134 and ground line 132 are not connected to inverter unit 502 yet, though inverter unit 502 is attached to the frame. In such a condition, a case can be considered where a surge due to static electricity and the like is applied to the connector portion to which the signal line is attached. In such a case, as control ground GNDS is in a floating state with respect to the body earth GNDB, the surge may be transmitted to an internal electronic component E11 when the surge applied to the terminal is extremely large such that it cannot be fully absorbed at zener diode D11.

Therefore, the worker who performs assembly operation needs to take sufficient measures for anti-static protection, possibly resulting in additional time and effort.

### DISCLOSURE OF THE INVENTION

An object of the present invention is to provide a vehicle-mounted electronic apparatus with improved anti-static performance and a vehicle having the electronic apparatus mounted therein.

The present invention, in summary, is a vehicle-mounted electronic apparatus, including a conductive housing, a control circuit board accommodated in the housing and a discharge gap provided between a conductive pattern formed at the control circuit board and the housing for discharging when a high voltage not less than a predetermined voltage is applied.

Preferably, the vehicle-mounted electronic apparatus further includes a conductive plate covering the control circuit board and electrically connected with the conductive pattern. The discharge gap is formed between the conductive plate and the housing.

More preferably, the conductive plate includes a first portion covering the control circuit board and a second portion provided at least partially outside the first portion and forming a discharge path. The distance of closest approach between the second portion and the housing is shorter than the distance of closest approach between the first portion and the housing.

Still more preferably, a projection directed towards the housing and forming the distance of closest approach is formed at the second portion.

Still more preferably, the vehicle-mounted electronic apparatus further includes an insulating member arranged between the second portion and the housing such that portions forming the distance of closest approach between the second portion and the housing do not contact.

Preferably, the housing is set to a ground potential when mounted in a vehicle.

Preferably, the vehicle-mounted electronic apparatus further includes a conductive body earth pattern forming a discharge gap between the conductive body earth pattern and the conductive pattern on the control circuit board, and a conductive member for electrically connecting the body earth pattern to the housing.

More preferably, the body earth pattern has a first projection directed towards the conductive pattern, and the conductive pattern has a second projection directed towards the first projection.

Preferably, the vehicle-mounted electronic apparatus further includes a terminal attached to the housing and connected to a wiring from outside. The terminal and the conductive pattern are electrically connected.

According to another aspect, the present invention is a vehicle including a vehicle-mounted electronic apparatus. The vehicle-mounted electronic apparatus includes a conductive housing, a control circuit board accommodated in the housing and a discharge gap provided between a conductive pattern formed at the control circuit board and the housing for discharging when a high voltage not less than a predetermined voltage is applied.

Preferably, the vehicle-mounted electronic apparatus further includes a conductive plate covering the control circuit board and electrically connected with the conductive pattern. The discharge gap is formed between the conductive plate and the housing.

More preferably, the conductive plate includes a first portion covering the control circuit board and a second portion provided at least partially outside the first portion and forming a discharge path. The distance of closest approach between the second portion and the housing is shorter than the distance of closest approach between the first portion and the housing.

Still more preferably, a projection directed towards the housing and forming the distance of closest approach is formed at the second portion.

Still more preferably, the vehicle-mounted electronic apparatus further includes an insulating member arranged between the second portion and the housing such that portions forming the distance of closest approach between the second portion and the housing do not contact.

Preferably, the housing is set to a ground potential when mounted in a vehicle.

Preferably, the vehicle-mounted electronic apparatus further includes a conductive body earth pattern forming a discharge gap between the conductive body earth pattern and the conductive pattern on the control circuit board, and a conductive member electrically connecting the body earth pattern to the housing.

More preferably, the body earth pattern has a first projection directed towards the conductive pattern, and the conductive pattern has a second projection directed towards the first projection.

Preferably, the vehicle-mounted electronic apparatus further includes a terminal attached to the housing and connected to a wiring from outside. The terminal and the conductive pattern are electrically connected.

According to the present invention, anti-static performance of the vehicle-mounted electronic apparatus is improved and noise immunity performance is still prevented from deteriorating.

### BRIEF DESCRIPTION OF THE DRAWINGS

FIG. 1 is a block diagram showing a configuration of a vehicle 100 according to Embodiment 1.

FIG. 2 is a diagram for describing a discharge gap 18.

FIG. 3 is a diagram for describing protection of a circuit board by discharge gap 18.

FIG. 4 is a plan view showing a specific configuration of inverter unit 1 shown in FIG. 1.

FIG. 5 is a cross sectional view showing the V-V cross section in FIG. 4.

FIG. 6 is a diagram for describing in detail the discharge gap and therearound shown in FIG. 4.

FIG. 7 is a cross sectional view showing the VII-VII cross section in FIG. 6.

FIG. 8 is a diagram for describing a first modification of Embodiment 1.

FIG. 9 is a cross sectional view showing the IX-IX cross section in FIG. 8.

FIG. 10 is a diagram for describing a second modification of Embodiment 1.

FIG. 11 is a diagram for describing the discharge gap of the inverter unit according to Embodiment 2.

FIG. 12 is a cross sectional view showing the XII-XII cross section in FIG. 11.

FIG. 13 is the first study example showing a connection between an inverter unit and a control ECU (Electric Control Unit).

FIG. 14 is a second study example showing a connection between an inverter unit and a control ECU.

FIG. 15 is a diagram for describing a problem of the study example shown in FIG. 14.

### BEST MODES FOR CARRYING OUT THE INVENTION

The embodiments of the present invention will be described in detail hereafter with reference to the drawings. The same or corresponding components are represented by the same reference characters in the drawings and the descriptions are not repeated.

### Embodiment 1

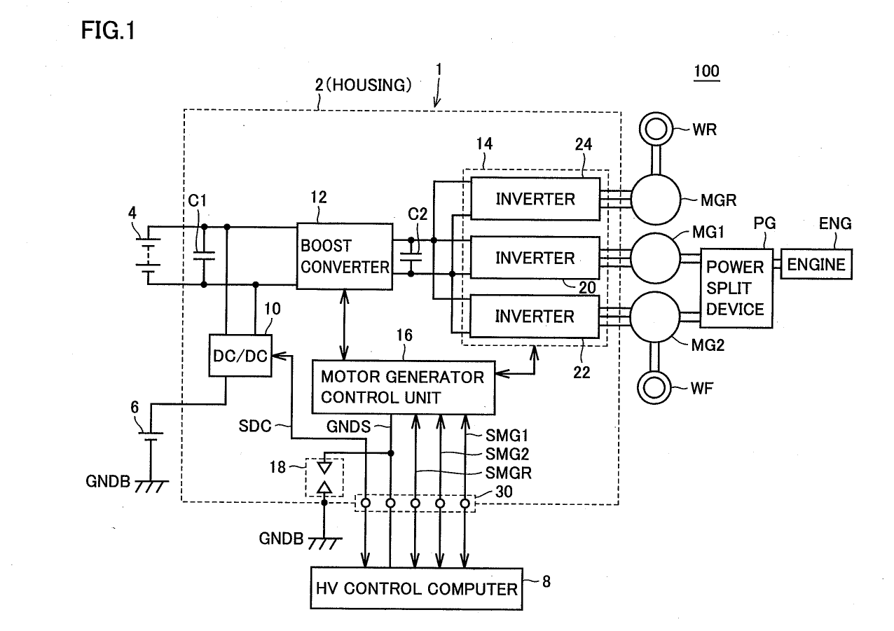

FIG. 1 is a block diagram showing a configuration of a vehicle 100 according to an embodiment of the present invention.

With reference to FIG. 1, vehicle 100 is a hybrid vehicle including a high voltage battery 4, an auxiliary battery 6, an inverter unit 1, an HV (hybrid) control computer 8, motor generators MG1, MG2 and MGR, a power split device PG, an engine ENG, a front wheel WF, and a rear wheel WR.

Power split device PG is a mechanism coupled to engine ENG and motor generators MG1 and MG2 for distributing power among these. For example, a planetary gear mechanism, which has three rotating shafts of a sun gear, a planetary carrier and a ring gear, can be used as the power split device. These three rotating shafts are connected to respective rotating shafts of engine ENG and motor generators MG1 and MG2, respectively. Note that a decelerator for the rotating shaft of motor generator MG 2 may further be incorporated inside power split device PG.

The rotating shaft of motor generator MG 2 drives front wheel WF via a reduction gear and/or a differential gear which are not shown. The rotating shaft of motor generator MGR drives rear wheel WR via a reduction gear and/or a differential gear which are not shown.

A secondary battery such as a nickel-hydrogen battery and a lithium ion battery and the like or a fuel cell and the like can be used as high voltage battery 4. A lead storage battery of 12V can be used as auxiliary battery 6, for example.

Inverter unit 1 includes a housing 2 and a connector 30 attached to housing 2, and a boost converter 12, an inverter IPM (Intelligent Power Module) 14, a motor generator control unit 16, and a DC/DC converter 10, each accommodated in housing 2. The signal line and the ground line extending from HV control computer 8 are attached to connector 30.

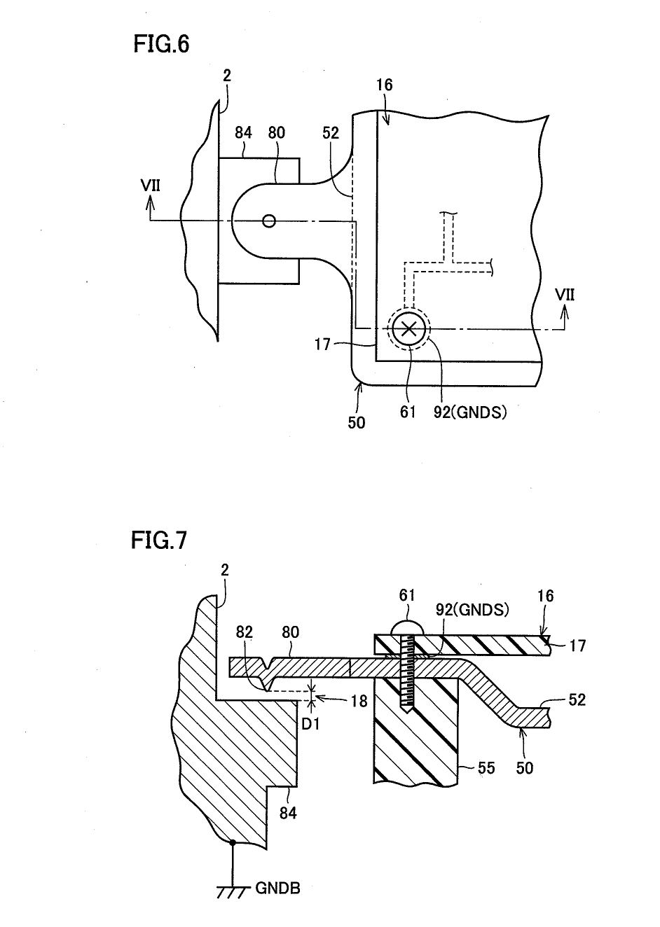

That is, inverter unit 1 further includes a terminal attached to housing 2 and having a wiring connected from outside. This terminal is the terminal inside connector 30, to which control ground GNDS is connected, and the terminal and a conductive pattern 92, later described in FIG. 6, are electrically connected.

Inverter IPM 14 includes inverters 20, 22 and 24. Boost converter 12 boosts the voltage between terminals of high voltage battery 4 and supplies the voltage to inverters 20, 22 and 24.

Inverter 20 converts a direct current voltage provided by boost converter 12 into a three-phase alternating current, and outputs the current to motor generator MG 1. Boost converter 12 is formed of a reactor, an IGBT (Insulated Gate Bipolar Transistor) element, and a diode and the like, for example.

Inverter 20 receives the boosted voltage from boost converter 12 and drives motor generator MG 1 in order to start engine ENG, for example. Moreover, inverter 20 returns electric power generated at motor generator MG 1 by mechanical power transmitted from engine ENG to boost converter 12. At this time, boost converter 12 is controlled by motor generator control unit 16 to operate as a step-down circuit.

Inverter 20 includes a U phase arm, a V phase arm and a W phase arm connected in parallel between a power source line and a ground line. Each phase arm of inverter 22 includes two IGBT elements connected in series between the power source line and the ground line, and two diodes connected in parallel with these two IGBT elements.

Motor generator MG 1 is a three-phase permanent magnet synchronous motor and its three U, V, and W phase coils each have one end connected to a midpoint together. The other end of each phase coil is connected to a corresponding phase arm of inverter 20.

Inverter 22 is connected to boost converter 12 in parallel with inverter 20. Inverter 22 converts a direct current voltage output by boost converter 12 into a three-phase alternating current and outputs the current to motor generator MG 2 for driving the wheel. Moreover, inverter 22 returns electric power generated at motor generator MG 2 to boost converter 12, at the same time with a regenerative braking. At this time, boost converter 12 is controlled by motor generator control unit 16 to operate as a step-down circuit.

Description is not repeated for the configuration of inverter 22, because it is the same as that of inverter 20. Motor generator MG 2 is a three-phase permanent magnet synchronous motor and its three U, V, and W phase coils each have one end connected to a midpoint together. The other end of each phase coil is connected to a corresponding phase arm of inverter 22.

Inverter 24 is connected to boost converter 12 in parallel with inverters 20, 22. Inverter 24 converts a direct current voltage output by boost converter 12 into a three-phase alternating current and outputs the current to motor generator MGR for driving the rear wheel. Moreover, inverter 24 returns electric power generated at motor generator MGR to boost converter 12, at the same time with a regenerative braking. At this time, boost converter 12 is controlled by motor generator control unit 16 to operate as a step-down circuit.

Description is not repeated for the configuration of inverter 24, because it is the same as that of inverter 20. Motor generator MGR is a three-phase permanent magnet synchronous motor and its three U, V, and W phase coils each have one end connected to a midpoint together. The other end of each phase coil is connected to a corresponding phase arm of inverter 24.

Motor generator control unit 16 receives a torque command value, the number of rotations of the motor and a motor current value from three motor generators, and values of the voltage between terminals of high voltage battery 4, the boosted voltage of boost converter 12 and the battery current. Motor generator control unit 16 outputs a boost command, a step-down command and an operation stop command to boost converter 12.

In addition, motor generator control unit 16 outputs to inverter 20, a drive command for converting the direct current voltage which is the output of boost converter 12 into the alternating current voltage for driving motor generator MG 1, and a regeneration command for converting the alternating current voltage generated at motor generator MG 1 into the direct current voltage and returning the voltage to the boost converter 12 side.

Similarly, motor generator control unit 16 outputs to inverter 22, a drive command for converting the direct current voltage into the alternating current voltage for driving motor generator MG 2, and a regeneration command for converting the alternating current voltage generated at motor generator MG 2 into the direct current voltage and returning the voltage to the boost converter 12 side.

Similarly, motor generator control unit 16 outputs to inverter 24, a drive command for converting the direct current voltage into the alternating current voltage for driving motor generator MGR, and a regeneration command for converting the alternating current voltage generated at motor generator MGR into the direct current voltage and returning the voltage to the boost converter 12 side.

DC/DC converter 10 steps down the voltage of high voltage battery 4 and charges auxiliary battery 6, or supplies electric power to a load connected to auxiliary battery 6, such as a headlight and the like which is not shown. DC/DC converter 10 transmits/receives a control signal SDC with HV control computer 8.

HV control computer 8 is connected to motor generator control unit 16 by the signal lines for transmitting/receiving control signals SMG1, MG2 and MGR which control motor generators MG1, MG2 and MGR, respectively, and the ground line for connecting control ground GNDS which is a reference of the signals.

The signal lines for transmitting/receiving control signals SMG1, MG2, MGR, and SDC, and the ground line for connecting control ground GNDS are connected to connector 30 from inside inverter unit 1. A group of wirings extending from HV control computer 8 are connected to these signal lines at connector 30.

Housing 2 of inverter unit 1 is electrically connected to body earth GNDB. This connection is implemented, for example, by fastening housing 2 formed of aluminum to a vehicle body frame with a bolt and a nut made of conductive metal.

A discharge gap 18 is provided between control ground GNDS and housing 2.

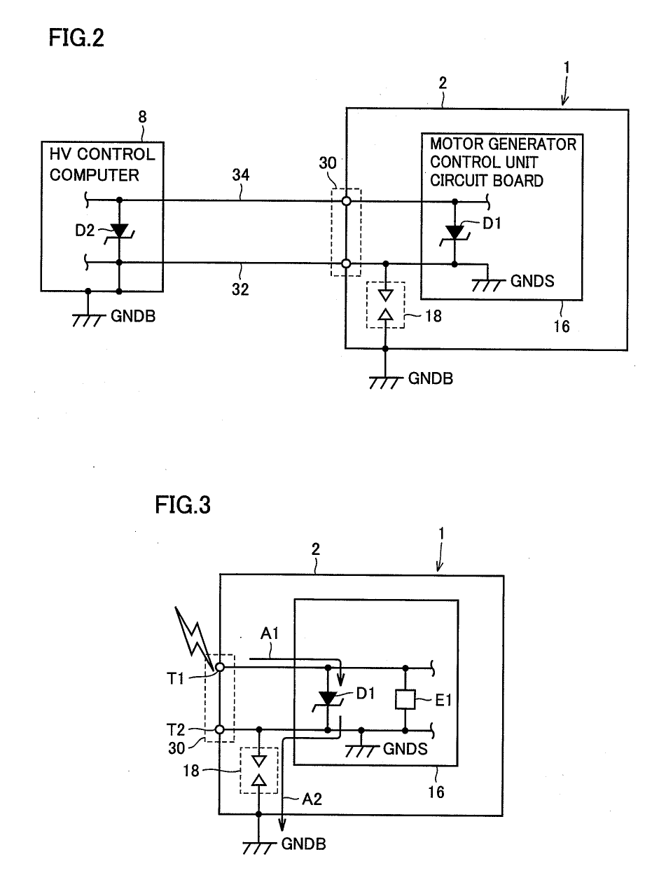

FIG. 2 is a diagram for describing discharge gap 18.

With reference to FIG. 2, HV control computer 8 and inverter unit 1 are connected by signal line 34 and ground line 32.

At the HV control computer 8 side, zener diode D2 is provided between signal line 34 and ground line 32, and ground line 32 is electrically connected to the housing of HV control computer 8. The housing of HV control computer 8 is electrically connected to body earth GNDB.

On the other hand, at the inverter unit 1 side, signal line 34 and ground line 32 are connected to the circuit board of motor generator control unit 16 inside housing 2. Zener diode D1 is provided, on the circuit board of motor generator control unit 16, between signal line 34 and ground line 32. Ground line 32 is connected to control ground GNDS. Note that control ground GNDS represents a reference potential of a signal provided by signal line 34. Moreover, inside inverter unit 1, discharge gap 18 is provided between ground line 32 and housing 2 of inverter unit 1. Housing 2 is electrically connected to body earth GNDB.

FIG. 3 is a diagram for describing protection of the circuit board by discharge gap 18.

With reference to FIG. 3, discharge gap 18 protects motor generator control unit 16, during the assembly process of a vehicle, by promptly allowing the voltage higher than the electrostatic withstand voltage of motor generator control unit 16 to escape to body earth GNDB via housing 2, when such a voltage is applied to connector terminals T1 and T2.

The high voltage due to static electricity applied to connector terminal T1 reaches zener diode D1 along the path indicated by an arrow A1 and a discharge is generated at discharge gap 18. The high voltage passes through zener diode D1 and escapes to body earth GNDB along the path indicated by an arrow A2. Therefore, it can be avoided that the high voltage is applied to internal electronic component E1.

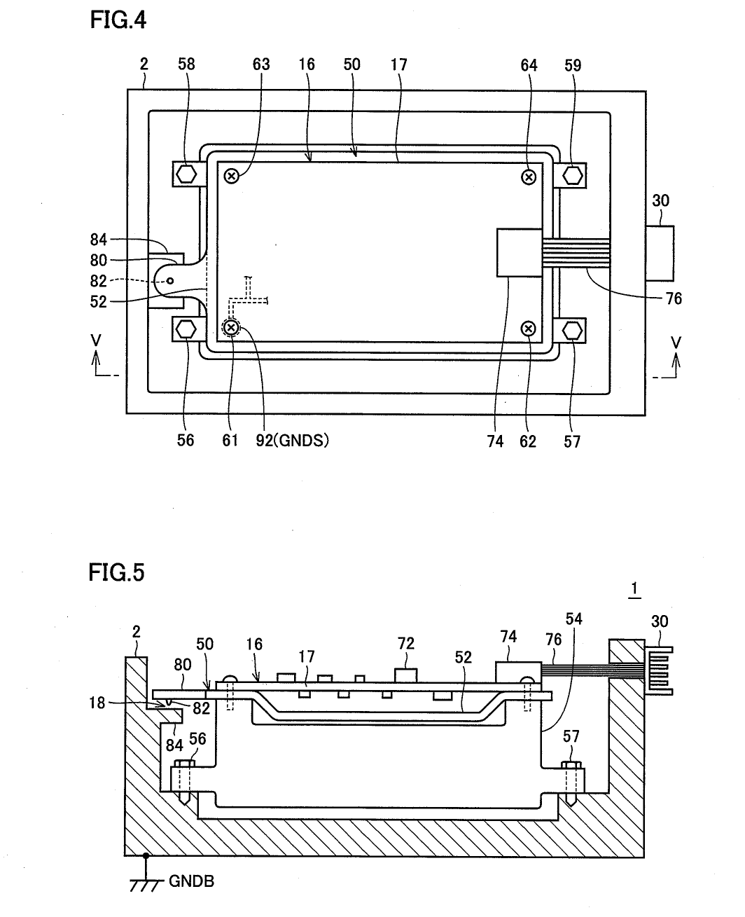

FIG. 4 is a plan view showing an example of the specific structure of inverter unit 1 shown in FIG. 1.

FIG. 5 is a cross sectional view showing the V-V cross section in FIG. 4.

With reference to FIGS. 4 and 5, inverter unit 1 includes conductive housing 2 set to a ground potential, a control circuit board 17 accommodated in housing 2, and discharge gap 18 between conductive pattern 92 formed at control circuit board 17 and housing 2 for discharging when the high voltage not less than a predetermined voltage (several kV, for example) is applied.

Housing 2 is formed of conductive metal such as aluminum and the like, for example. A resin case 54 for accommodating a power element, a capacitor and the like is arranged in housing 2. On a lower part of a side surface of resin case 54, a portion overhanging from the body for accepting a bolt is provided. Resin case 54 is fixed with bolts 56-58.

Inverter unit 1 further includes connector 30 to which the signal line and the ground line are connected from outside and a wiring 76 for connecting connector 30 and a connector 74 on the control circuit board. Wiring 76 connects a terminal of connector 74 to which the ground line is connected and conductive pattern 92 which is a control ground on control circuit board 17. Conductive pattern 92 is formed on an undersurface of control circuit board 17.

Inverter unit 1 further includes a conductive plate 50 covering control circuit board 17 from underside and electrically connected with conductive pattern 92. An electronic component 72 which is susceptible to noise is mounted on control circuit board 17. Conductive plate 50 has a shielding function to protect control circuit board 17 from the noise generated by the power element inside resin case 54 and also serves as a discharge path for discharging static electricity. Housing 2 is provided with an overhang projection 84 which is provided partially on an inner sidewall. Discharge gap 18 is formed between conductive plate 50 and overhang projection 84 of housing 2.

A boss (projected portion) for fixing control circuit board 17 is provided at each of four corners of a top surface of resin case 54. Conductive plate 50 is arranged on the bosses, on which control circuit board 17 is further arranged, and control circuit board 17 and conductive plate 50 are fixed to the boss on the upper part of resin case 54 with screws 61-64. Conductive pattern 92 formed at control circuit board 17 and conductive plate 50 are electrically connected as a result of screw 61 being fastened.

FIG. 6 is a diagram for describing in detail the proximity of the discharge gap and therearound shown in FIG. 4.

FIG. 7 is a cross sectional view showing the VII-VII cross section in FIG. 6.

With reference to FIGS. 6 and 7, conductive plate 50 includes a first portion 52 covering control circuit board 17 and a second portion 80 provided at least partially outside the first portion 52 and forming a discharge path. Note that first portion 52 is a shielding plate for hindering noise from transmitted from the power element and the like accommodated in resin case 54 to control circuit board 17. A distance of closest approach D1 between second portion 80 and housing 2 is shorter than a distance of closest approach between first portion 52 and the housing. Distance D1 can be for example in a range from 0.1 mm to 1.5 mm, and preferably about 1 mm.

Note that the voltage to be considered and distance D1 are generally in a proportional relation. Although a shorter distance D1 is more preferable in view of anti-static protection, distance D1 may be determined considering an electrostatic withstand voltage of control circuit board 17 itself, such that a discharge is generated when a high voltage exceeding the electrostatic withstand voltage is applied, taking the dimension tolerance at the time of manufacturing a component and the dimension error at the time of installation into consideration.

By setting distance D1 in this way, a discharge is generated at discharge gap 18 when the high voltage due to static electricity is applied and control circuit board 17 is protected.

A projection 82 directed towards the housing and forming the distance of closest approach is formed at second portion 80. For example, this projection 82 can be formed by pressing a metal plate. Note that the discharge gap is formed between second portion 80 and housing 2 even without projection 82, provided that the distance of closest approach between second portion 80 and housing 2 is shorter than the distance of closest approach between first portion 52 and housing 2. For example, an end portion may be provided closer to the sidewall.

As described above, the electrostatic withstand voltage of the inverter unit can be improved in Embodiment 1, without the ground loop being formed in a vehicle.

[First Modification]

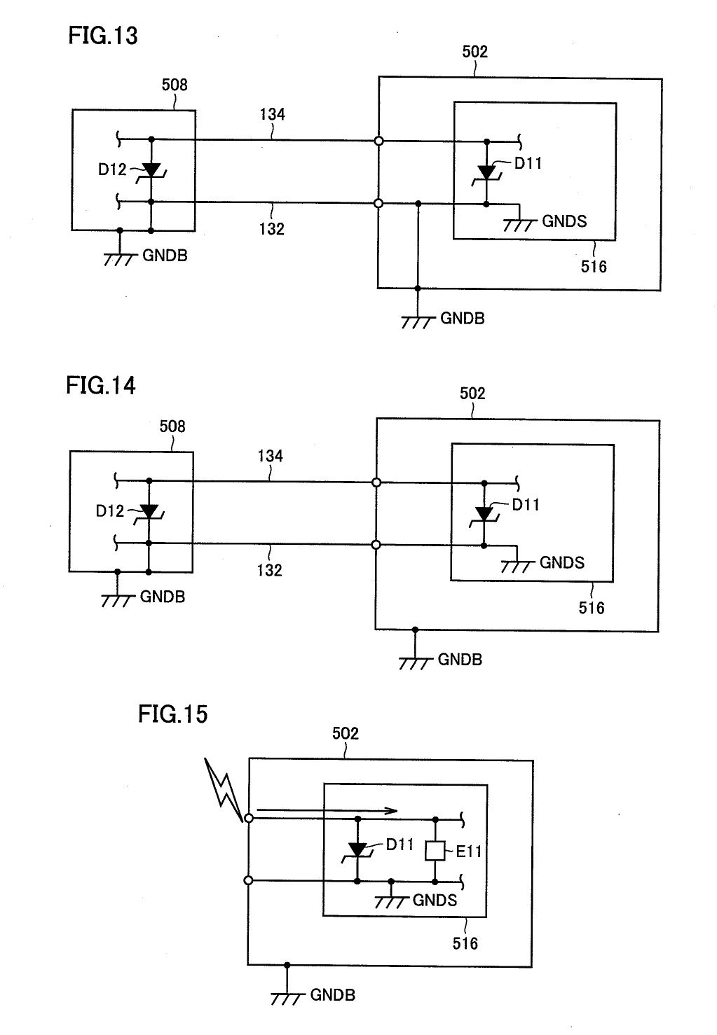

As described with reference to FIG. 5, in such a configuration that resin case 54 is fixed to housing 2 and conductive plate 50 is further fixed onto the resin case, it is difficult to keep the dimension of the discharge gap constant without variation. It is because the dimension error of the height of resin case 54 and the dimension error of a bolt or a screw fastening portion accumulate. Therefore, if the dimension variations of such portions add up in a way that the gap becomes smaller, projection 82 may even contact housing 2. Then, as described with reference to FIG. 13, the ground loop may be generated and the electronic apparatus may be susceptible to the noise.

In order to keep the discharge gap constant, the manufacturing cost increases because the dimension tolerance of a component such as the height of resin case 54 and the like and the tightening torque of a bolt or a screw must be more strictly managed.

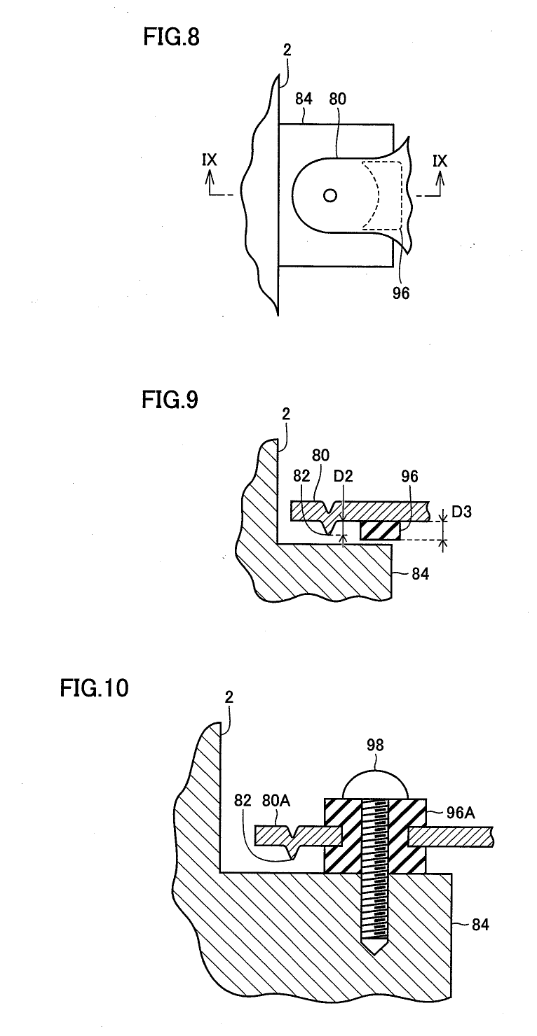

FIG. 8 is a diagram for describing a first modification of Embodiment 1.

FIG. 9 is a cross sectional view showing the IX-IX cross section in FIG. 8.

With reference to FIGS. 8 and 9, the inverter unit according to the first modification further includes, in addition to the configuration of the conductive plate shown in FIG. 7, an insulating member 96 arranged between second portion 80 and housing 2 such that the portions forming the distance of closest approach between second portion 80 and housing 2 do not contact. Description is not repeated for the configuration of other portions because it is the same as that in Embodiment 1. While insulating paper can be used as insulating member 96, for example, any kind of items can be used as long as it is an insulator.

A thickness D3 of insulating member 96 needs to be not less than a height D2 of projection 82. By setting the height in such a relation, it can be avoided that projection 82 contacts housing 2, without strictly managing the dimension tolerance of a component such as the height of resin case 54 and the like and the tightening torque of a bolt or a screw.

[Second Modification]

FIG. 10 is a diagram for describing a second modification of Embodiment 1.

With reference to FIG. 10, the inverter unit according to the first modification includes a second portion 80A with a screw through hole provided, in place of second portion 80 of the conductive plate shown in FIG. 7. Description is not repeated for the configuration of other portions because it is the same as that in Embodiment 1.

The inverter unit according to the first modification further includes an insulating member 96A arranged between second portion 80A and housing 2 such that the portions forming the distance of closest approach between second portion 80A and housing 2 do not contact. This insulating member 96A is formed, for example, of resin and the like. A through hole for allowing a screw 98 to pass through is provided in the center of insulating member 96A. Such insulating member 96A can be formed by an integral molding, for example, with resin sandwiching the conductive plate. Such a shape may also be formed by molding resin into an upper part and a lower part as separate members and fitting the parts onto the conductive plate from both sides.

When the insulating member is formed to such a shape and second portion 80A of the conductive plate is fixed by screw 98 and insulating member 96A in the proximity of projection 82, it is not only possible to avoid forming of the ground loop but also possible to manage the dimension of the discharge gap with more accuracy.

### Embodiment 2

Although the discharge gap is formed between the conductive plate and the housing in Embodiment 1, the discharge gap can be formed in other portions.

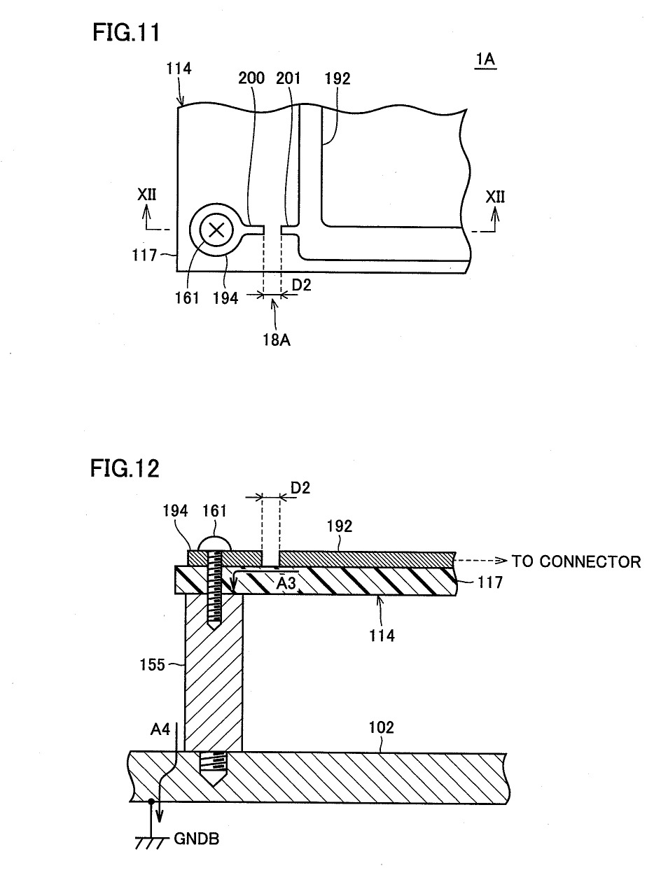

FIG. 11 is a diagram for describing the discharge gap of the inverter unit according to Embodiment 2.

FIG. 12 is a cross sectional view showing the XII-XII cross section in FIG. 11.

With reference to FIGS. 11 and 12, an inverter unit 1A further includes a conductive body earth pattern 194 forming a discharge gap 18A between the conductive body earth pattern and a conductive pattern 192 on a control circuit board 117, a spacer 155 and a screw 161 which are conductive members electrically connecting body earth pattern 194 to a housing 102. A male screw is formed in the lower part of spacer 155 and threaded into a screw hole formed in housing 102. In the upper part of spacer 155, a hole with a female screw formed on the inner wall is provided. Control circuit board 117 is clamped to spacer 155 with screw 161. As the head of screw 161 and body earth pattern 194 abut with each other, housing 102 connected to body earth GNDB and body earth pattern 194 are electrically connected via conductive spacer 155.

More preferably, body earth pattern 194 has a first projection 200 directed towards conductive pattern 192, and conductive pattern 192 has a second projection 201 directed towards first projection 200. Discharge gap 18A is formed between first projection 200 and second projection 201. These projections are not used for transmitting a signal in an ordinary condition of use.

A distance D2 of discharge gap 18A can be set in a range from 0.1 mm to 1.5 mm, preferably about 1 mm.

With the above-described configuration, the high voltage due to static electricity applied at the connector is discharged from conductive pattern 192 along the path indicated by an arrow A3, and is transmitted to screw 161, and escapes to body earth GNDB along the path indicated by an arrow A4 through spacer 155.

Therefore, in Embodiment 2 as well as in Embodiment 1, the ground loop in the vehicle is not formed and the electrostatic withstand voltage of the inverter unit can be improved.

Note that the present embodiment is described for the case where the vehicle-mounted electronic apparatus is an inverter unit, however, the present invention can be applied to a wide range of electronic apparatuses for a vehicle.

Moreover, although the description is given above of the case where the vehicle is a hybrid vehicle which uses an engine and a motor for driving the vehicle, the present invention can be used for other vehicles which mount an inverter using a motor, such as an electric vehicle or a fuel cell vehicle, or which mount other electronic apparatuses.

The embodiments and examples disclosed herein are by way of example in all respects and should not be interpreted as restrictive. The scope of the present invention is determined not by the above description but by the appended claims, and intended to include all the modifications within the meaning and the scope equivalent to those of the claims.

1. A vehicle-mounted electronic apparatus comprising:
a conductive housing;
a control circuit board accommodated in said housing; and
a discharge gap provided between a conductive pattern formed at said control circuit board and said housing for discharging when a high voltage not less than a predetermined voltage is applied.

2. The vehicle-mounted electronic apparatus according to claim 1, further comprising:
a conductive plate covering said control circuit board and electrically connected with said conductive pattern, wherein
said discharge gap is formed between said conductive plate and said housing.

3. The vehicle-mounted electronic apparatus according to claim 2, wherein
said conductive plate includes:
a first portion covering said control circuit board; and
a second portion provided at least partially outside said first portion and forming a discharge path, and
a distance of closest approach between said second portion and said housing is shorter than a distance of closest approach between said first portion and said housing.

4. The vehicle-mounted electronic apparatus according to claim 3, wherein
a projection directed towards said housing and forming the distance of closest approach is formed at said second portion.

5. The vehicle-mounted electronic apparatus according to claim 3, further comprising:
an insulating member arranged between said second portion and said housing such that portions forming the distance of closest approach between said second portion and said housing do not contact.

6. The vehicle-mounted electronic apparatus according to claim 1, wherein
said housing is set to a ground potential when mounted in a vehicle.

7. The vehicle-mounted electronic apparatus according to claim 1, further comprising:
a conductive body earth pattern forming said discharge gap between said conductive body earth pattern and said conductive pattern on said control circuit board; and
a conductive member electrically connecting said body earth pattern to said housing.

8. The vehicle-mounted electronic apparatus according to claim 7, wherein
said body earth pattern has a first projection directed towards said conductive pattern, and said conductive pattern has a second projection directed towards said first projection.

9. The vehicle-mounted electronic apparatus according to claim 1, further comprising a terminal attached to said housing and connected to a wiring from outside, wherein said terminal and said conductive pattern are electrically connected.

10. A vehicle including a vehicle-mounted electronic apparatus,
said vehicle-mounted electronic apparatus comprising:
a conductive housing;
a control circuit board accommodated in said housing; and
a discharge gap provided between a conductive pattern formed at said control circuit board and said housing for discharging when a high voltage not less than a predetermined voltage is applied.

11. The vehicle according to claim 10, wherein
said vehicle-mounted electronic apparatus further comprises a conductive plate covering said control circuit board and electrically connected with said conductive pattern, said discharge gap being formed between said conductive plate and said housing.

12. The vehicle according to claim 11, wherein
said conductive plate includes:
a first portion covering said control circuit board; and
a second portion provided at least partially outside the first portion and forming a discharge path, and
a distance of closest approach between said second portion and said housing is shorter than a distance of closest approach between said first portion and said housing.

13. The vehicle according to claim 12, wherein
a projection directed towards said housing and forming the distance of closest approach is formed at said second portion.

14. The vehicle according to claim 12, wherein
said vehicle-mounted electronic apparatus further comprises:
an insulating member arranged between said second portion and said the housing such that portions forming the distance of closest approach between said second portion and said housing do not contact.

15. The vehicle according to claim 10, wherein
said housing is set to a ground potential when mounted in the vehicle.

16. The vehicle according to claim 10, wherein
said vehicle-mounted electronic apparatus further comprises:
a conductive body earth pattern forming said discharge gap between said conductive body earth pattern and said conductive pattern on said control circuit board; and
a conductive member electrically connecting said body earth pattern to said housing.

17. The vehicle according to claim 16, wherein
said body earth pattern has a first projection directed towards said conductive pattern, and said conductive pattern has a second projection directed towards said first projection.

18. The vehicle according to claim 10, wherein
said vehicle-mounted electronic apparatus further comprises a terminal attached to said housing and connected to a wiring from outside, and said terminal and said conductive pattern are electrically connected.
